(19) United States
(12) Patent Application Publication
(10) Pub. No.: US 2020/0176916 A1
(43) Pub. Date: Jun. 4, 2020

(54) POWER CONNECTOR DEVICE INCLUDING IMPROVED TERMINAL

(71) Applicant: HIROSE ELECTRIC CO., LTD., Tokyo (JP)

(72) Inventors: Koichi NAKAMURA, Tokyo (JP); Takahiro SHIMURA, Tokyo (JP)

(21) Appl. No.: 16/668,316

(22) Filed: Oct. 30, 2019

(30) Foreign Application Priority Data
Nov. 2, 2018 (JP) 2018-207548

(51) Int. Cl. H01R 13/422; H01R 13/04; H01R 13/50

(52) U.S. Cl. CPC H01R 13/4223; H01R 13/50; H01R 13/04

(57) ABSTRACT

[PROBLEM] To provide a power connector including a terminal having a metal member and a resin member and configured such that the metal member and the resin member are firmly fixed to each other and a portion connected to a partner connector has sufficient strength and a power connector device using the power connector.

[SOLUTION] A power connector includes a housing having a fitting space in which a predetermined portion of a partner connector is to be fitted and a terminal attached to the housing. The terminal includes a metal member and a resin member molded integrally with the metal member. The metal member has a tubular portion electrically connected to a partner terminal of the partner connector arranged in the fitting space. The resin member has a charged portion charged into the tubular portion and a cover portion covering the outside of the metal member in a state in which at least part of the tubular portion is exposed to the outside.

### TECHNICAL FIELD

The present invention relates to a power connector used in, e.g., a power system of an automobile. More specifically, the present invention relates to, e.g., a power connector including a housing forming a fitting space in which a predetermined portion of a partner connector is to be fitted and a terminal attached to the housing and a connector device using the power connector.

### BACKGROUND ART

JP-A-2018-37147 (Patent Literature 1) describes one example of a power connector and a connector device including the power connector and a partner connector fittably connected to the power connector. The power connector includes a housing and a connection terminal detachably housed in a terminal housing portion provided at the housing. The connection terminal includes a terminal body made of a conductive metal material and a support member made of an electrical insulating synthetic resin material. The terminal body is formed in such a manner that a thin metal plate is punched out and is processed by bending.

At the connection terminal, the support member is molded integrally with the terminal body. However, the terminal body molded integrally with the support member is in the shape of the plate formed by punching out of the metal plate, and the support member is merely fixed to a plate surface of the metal plate. For this reason, there is a probability that in a case where the force of separating these members is applied, the support member and the terminal body are separated from each other. Moreover, the terminal body is in the shape of the thin plate, and for this reason, does not have sufficient strength and there is a probability that the terminal body is damaged upon connection to the partner connector.

### CITATION LIST

### Patent Literature

[PATENT LITERATURE 1] JP-A-2018-37147

### SUMMARY OF THE INVENTION

### Problems to be Solved by the Invention

The invention of the present application has been made for solving the problems in the above-described typical technique, and is intended to provide a power connector including a terminal having a metal member (a terminal body) and a resin member (a support member) and configured such that the metal member and the resin member are firmly fixed to each other and a portion connected to a partner connector has sufficient strength and a power connector device using the power connector.

### Solutions to the Problems

For solving the above-described problems, a power connector according to one aspect of the present invention includes a housing having a fitting space in which a predetermined portion of a partner connector is to be fitted and a terminal attached to the housing. The terminal includes a metal member and a resin member molded integrally with the metal member. The metal member has a tubular portion electrically connected to a partner terminal of the partner connector arranged in the fitting space. The resin member has a charged portion charged into the tubular portion and a cover portion covering the outside of the metal member in a state in which at least part of the tubular portion is exposed to the outside.

In the power connector of the above-described aspect, the tubular portion may be arranged in the fitting space by means of the cover portion.

Moreover, in the power connector of the above-described aspect, the tubular portion may be formed in such a manner that a side surface along a fitting direction of the fitting space and the predetermined portion is wound in a lateral direction.

Further, in the power connector of the above-described aspect, when the terminal is attached to the housing, the tubular portion preferably extends along the fitting direction.

In addition, in the power connector of the above-described aspect, the metal member may be formed from a single plate-shaped body.

Further, in the power connector of the above-described aspect, at least part of the metal member covered with the cover portion may stand in a direction crossing the fitting direction of the fitting space and the predetermined portion.

In addition, in the power connector of the above-described aspect, the resin member preferably covers one end of the tubular portion on the side of fitting between the fitting space and the predetermined portion.

Further, in the power connector of the above-described aspect, one end of the tubular portion is, in the fitting direction of the fitting space and the predetermined portion, preferably at a position recessed to the opposite side of the side of fitting between the fitting space and the predetermined portion of the partner connector with respect to a fitting inlet of the fitting space.

In addition, the present invention is a terminal including a metal member and a resin member molded integrally with the metal member. The metal member has a tubular portion electrically connected to a partner terminal of the partner connector upon fitting to the partner connector. The resin member has a charged portion charged into the tubular portion, and covers one end of the tubular portion on the side of fitting to the partner connector.

### Effects of the Invention

According to the invention of the present application, the power connector including the terminal having the metal member (the terminal body) and the resin member (the support member) and configured such that the metal member and the resin member are firmly fixed to each other and the portion connected to the partner connector has sufficient strength and the power connector device using the power connector are provided, for example.

### BRIEF DESCRIPTION OF THE DRAWINGS

FIG. 1 is a perspective view of a power connector device according to one embodiment of the present invention.

FIG. 2 is a side view of the power connector device of FIG. 1.

FIG. 3 is a back view of the power connector device of FIG. 1.

FIG. 4 is a sectional view along an A-A line of FIG. 3.

FIG. 5 is a sectional view along a B-B line of FIG. 3.

FIG. 6 is a perspective view of a power connector according to one embodiment of the present invention.

FIG. 7 is a front view of a male connector as the power connector according to one embodiment of the present invention.

FIG. 8 is a sectional view along a C-C line of FIG. 7.

FIG. 9 is a sectional view corresponding to the sectional view of FIG. 4, FIG. 9 illustrating only the male connector.

FIG. 10 is a front view of a female connector.

FIG. 11 is a sectional view corresponding to the sectional view of FIG. 4, FIG. 11 illustrating only the female connector.

FIGS. 12A and 12B are perspective views of a terminal according to one embodiment of the present invention.

FIG. 13A to 13C are side and sectional views of the terminal according to one embodiment of the present invention.

FIGS. 14A and 14B are perspective views of a metal member forming the terminal according to one embodiment of the present invention.

FIGS. 15A and 15B are side and back views of the metal member forming the terminal according to one embodiment of the present invention.

### DESCRIPTION OF THE EMBODIMENTS

Hereinafter, one preferred embodiment of the present invention will be described with reference to the attached drawings. Although only the preferred embodiment will be described, such an embodiment is not intended to limit the present invention, needless to say.

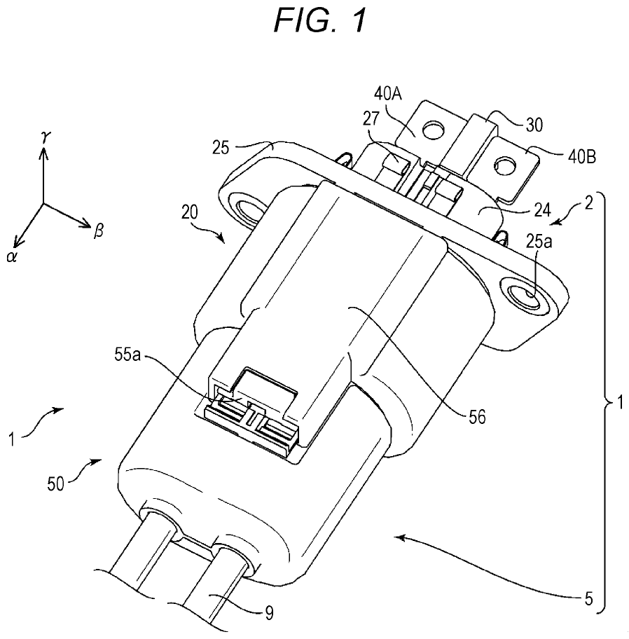

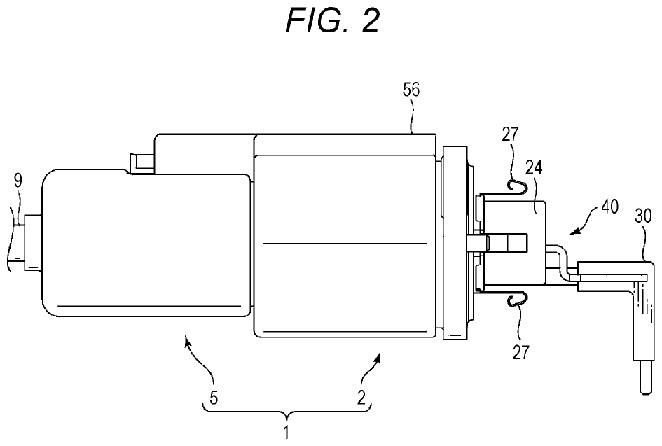

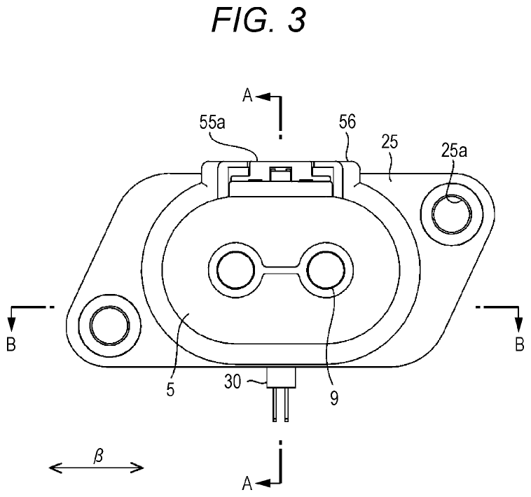

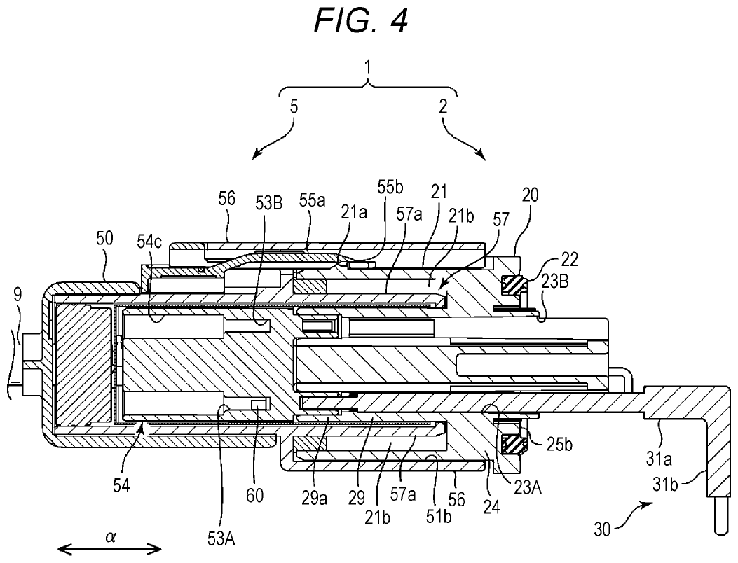

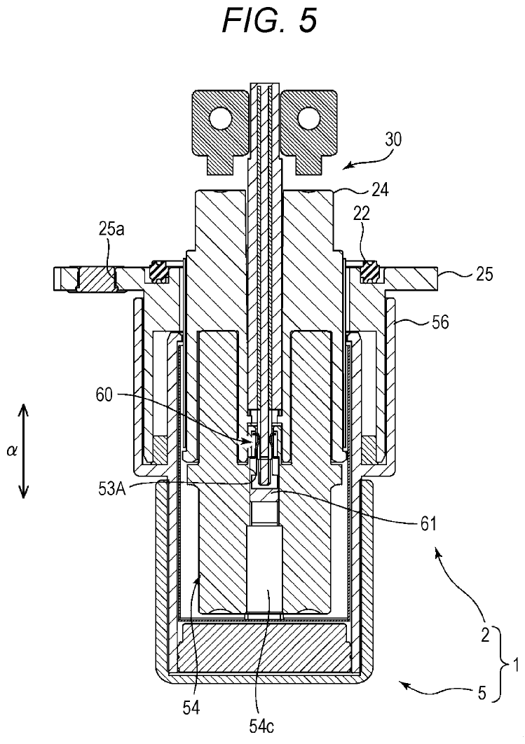

FIGS. 1 to 5 illustrate a power connector device 1 according to one embodiment of the present invention, the power connector device 1 being used in a power system of an automobile, for example. FIG. 1 is a perspective view of the power connector device 1, FIG. 2 is a side view thereof, FIG. 3 is a back view thereof, FIG. 4 is a sectional view along an A-A line of FIG. 3, and FIG. 5 is a sectional view along a B-B line of FIG. 3. The power connector device 1 includes a pair of a male connector 2 and a female connector 5 according to one embodiment of the present invention, the male connector 2 and the female connector 5 being able to be fittably connected to each other. FIGS. 1 to 5 illustrate a state after the male connector 2 and the female connector 5 have been fittably connected to each other. The male connector 2 and the female connector 5 can be fittably connected to each other along a fitting direction “α,” and can be disconnected from each other.

The female connector 5 can be, for example, used as a cable connector with the female connector 5 being fixed to one end of a cable 9. On the other hand, the male connector 2 can be, for example, used in a state in which the male connector 2 is fixed to a housing (not shown). Attachment to the housing is, for example, performed in the following method.

The back of a flange 25, i.e., an annular portion 25b of a terminal support portion 24 of the male connector 2 protruding to a side fixed to the housing, is inserted into a wall hole of the housing along the fitting direction “α,” and in a state in which a packing 22 is sandwiched between the flange 25 and a wall surface of the housing, an attachment spring 27 provided at each of upper and lower surfaces of the terminal support portion 24 is sandwiched by the wall hole. Thereafter, fixing to the housing wall surface with screws is performed utilizing screw holes 25a provided at the flange 25.

A locking unit may be provided to lock fittable connection between the male connector 2 and the female connector 5. A locking protrusion 21a protruding upward is, as the locking unit, provided on an upper surface of an outermost shell 21 of a housing 20 of the male connector 2. A locking piece 55a extending in the shape of a cantilever along the fitting direction “α” toward a side fittably connected to the male connector 2 is provided corresponding to the locking protrusion 21a inside an outermost shell 56 of a housing 50 of the female connector 5. Upon fittable connection between the male connector 2 and the female connector 5, the locking protrusion 21a of the housing 20 of the male connector 2 extends into the inside of the outermost shell 56 of the housing 50 of the female connector 5, and a locking protrusion 55b provided at a tip end of the locking piece 55a is locked at the locking protrusion 21a provided at the outermost shell 56 of the male connector 2.

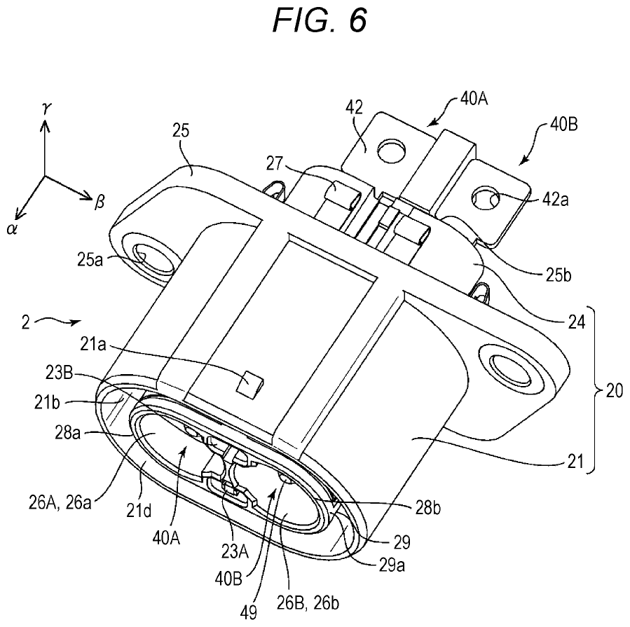

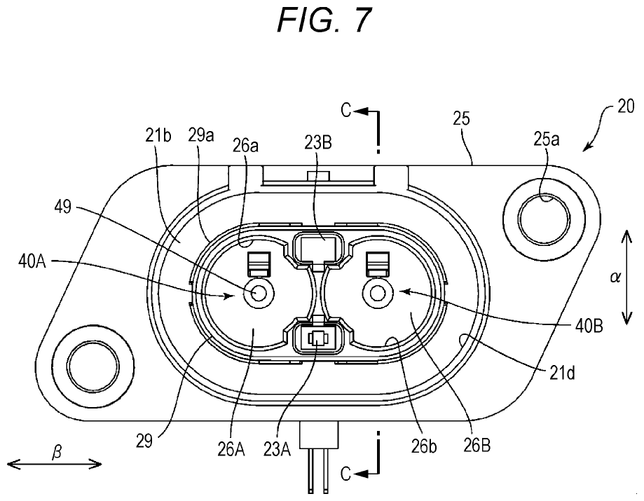

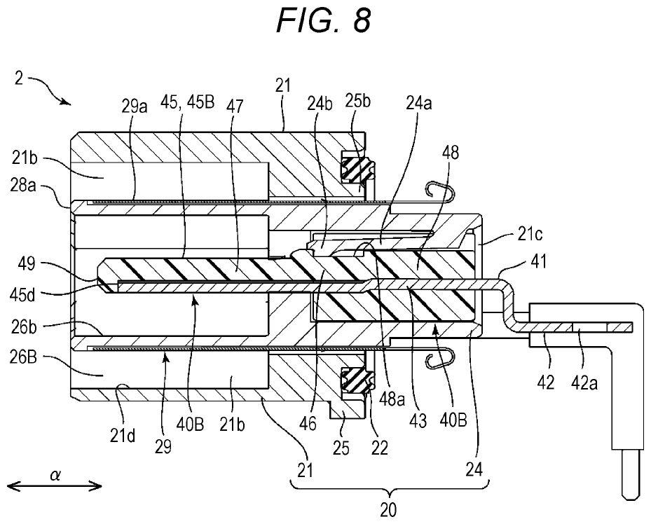

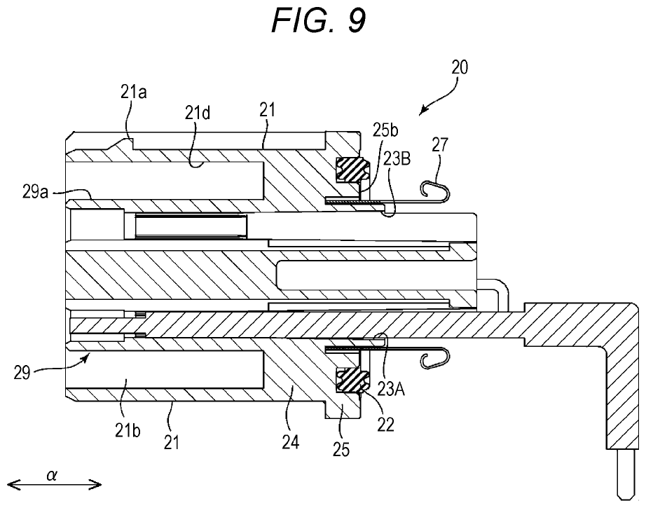

FIGS. 6 to 9 illustrate views of the individual male connector 2, i.e., illustrate the male connector 2 before fittable connection between the male connector 2 and the female connector 5 or after disconnection of the male connector 2 and the female connector 5 from each other. FIG. 6 is a perspective view of the male connector 2, FIG. 7 is a front view thereof, FIG. 8 is a sectional view along a C-C line of FIG. 7, and FIG. 9 illustrates only the male connector 2 in the sectional view of FIG. 4.

The male connector 2 includes the housing 20, terminals 40A, 40B of one embodiment of the present invention attached to the housing 20, and an interlock connector 30 (see FIG. 1 etc.). The terminals 40A, 40B and the interlock connector 30 are detachable from the housing 20.

The housing 20 includes the outermost shell 21 and the terminal support portion 24. The outermost shell 21 covers, in an annular shape, the outside of a front protruding portion 29 as part of the terminal support portion 24 protruding to a side fittably connected to the female connector 5. For facilitating fixing of the male connector 2 to, e.g., the housing, the above-described flange 25 may be further provided.

The outermost shell 21 and the front protruding portion 29 substantially have bilaterally-symmetrical shapes on the side of fittable connection between the male connector 2 and the female connector 5. By employing the symmetrical shapes, it is not necessary to take the directions of the male connector 2 and the female connector 5 into consideration upon fittable connection between the male connector 2 and the female connector 5. The phrase of “substantially have bilaterally-symmetrical shapes” means that it is enough to provide symmetry to such an extent that the direction of fittable connection between the male connector 2 and the female connector 5 causes no problem upon fittable connection (the same applies hereinafter).

Both of the outermost shell 21 and the terminal support portion 24 extend along the fitting direction “α,” and are formed in a substantially tubular shape. As clearly illustrated in FIG. 7, an inner surface 21dof the outermost shell 21 and an outer surface 29a of the front protruding portion 29 of the terminal support portion 24 are in concentric flat oval sectional shapes, and the front protruding portion 29 is positioned at the substantially center of the outermost shell 21. Such a sectional shape forms a surface abutting on a predetermined member of the female connector 5, and therefore, it may be understood that FIG. 7 substantially illustrates the surface of the male connector 2 abutting on the predetermined member of the female connector 5. The diameter of the inner surface 21dof the outermost shell 21 is greater than the diameter of the outer surface 29a of the front protruding portion 29, and therefore, an annular fitting recessed portion 21b is formed between these portions. A predetermined portion of the female connector 5 can be fitted in the fitting recessed portion 21b upon fittable connection between the male connector 2 and the female connector 5.

The terminal support portion 24 includes, specifically at an abutting surface of the front protruding portion 29 of the terminal support portion 24, two fitting portions 26A, 26B in which predetermined portions (52A, 52B) of the female connector 5 are to be fitted, and attachment portions 23A, 23B to which the interlock connector 30 is to be attached. At such an abutting surface, the fitting portions 26A, 26B are arrayed in a lateral direction along a direction “β” perpendicular to the fitting direction “α” The fitting portions 26A, 26B are formed as recessed portions recessed along the fitting direction “α,” and are formed as bottomed tubular portions. An inner peripheral edge of the fitting recessed portion 26A is defined by an inner wall 26a of the tube, and similarly, an inner peripheral edge of the fitting recessed portion 26B is defined by an inner wall 26b of the tube. These inner peripheral edges 26a, 26b have, for example, shapes slightly recessed inward at positions corresponding to the attachment portions 23A, 23B. As in the fitting recessed portions 26A, 26B, the attachment portions 23A, 23B are also provided along the fitting direction “α,” and are formed as recessed portions. Note that these portions are not formed in a tubular shape, but are formed as through-holes. The terminals 40A, 40B are each inserted into the fitting recessed portions 26A, 26B through an insertion port 21c provided at the terminal support portion 24 from a back end side of the terminal support portion 24, i.e., the opposite side of the surface abutting on the predetermined member of the female connector 5, and are each placed in the fitting recessed portions 26A, 26B. Upon placement in the fitting recessed portions 26A, 26B, tip-end-side terminal portions (tubular portions) 45 of the terminals 40A, 40B extend along the fitting direction “α” in a fitting space formed by the fitting recessed portions 26A, 26B, and at the abutting surface, are positioned at the substantially centers of the inner peripheral edges 26a, 26b of the fitting recessed portions 26A, 26B.

One end 49 of each of the terminals 40A, 40B on the side of the surface abutting on the predetermined member of the female connector 5 is covered utilizing a resin member 46. The resin member covering one end 49 functions as a finger protection. One end 49 is, in the fitting direction “α,” at a position recessed to the opposite side of the side of fittable connection between the male connector 2 and the female connector 5, i.e., the opposite side of the side of fitting in the predetermined portion (52A, 52B) of the female connector 5, with respect to a fitting inlet 28a, 28b of the fitting recessed portion 26A, 26B. Since the tip ends 49 are at these positions, the function as the finger protection can be enhanced.

Note that the outline of the terminal portion 45 at the abutting surface is preferably a substantially circular shape. With the substantially circular shape, the male connector 2 can be downsized in the array direction “β” of the fitting recessed portions 26A, 26B as compared to the case of a flat plate shape, for example. For fixing the terminals 40A, 40B, locking pieces 24a extending toward the abutting surface from the insertion port 21c are provided at the terminal support portion 24. At tip ends of the locking pieces 24a, locking protrusions 24b to be locked at predetermined portions of the terminals 40A, 40B are provided.

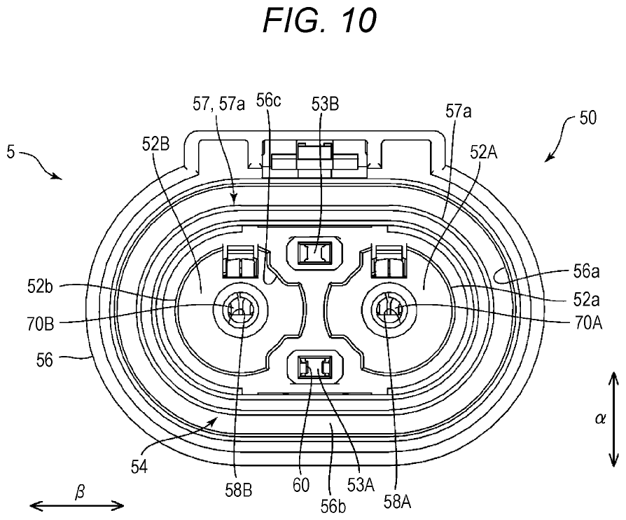

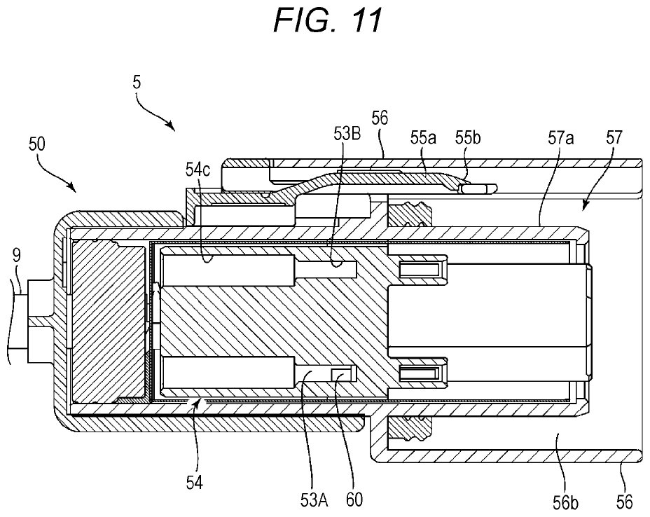

FIG. 10 illustrates a front view of the female connector 5, and FIG. 11 illustrates the female connector 5 in the sectional view of FIG. 4. FIGS. 10 and 11 each correspond to FIGS. 7 and 8 illustrating the male connector 2.

As in the male connector 2, the female connector 5 includes the housing 50, terminals 70A, 70B attached to the housing 50, and an interlock connector 60 (see FIG. 5 etc.). The terminals 70A, 70B and the interlock connector 60 may be detachable from the housing 50.

The housing 50 includes the outermost shell 56 and a terminal support portion 54. The outermost shell 56 covers, in an annular shape, the outside of a front protruding portion 57 as part of the terminal support portion 54 protruding to the side fittably connected to the male connector 2. The terminals 70A, 70B are supported by the terminal support portion 54, and one end of the cable 9 is fixed to the terminal support portion 54.

The outermost shell 56 and the front protruding portion 57 substantially have bilaterally-symmetrical shapes on the side of fittable connection between the male connector 2 and the female connector 5. By employing the symmetrical shapes, it is not necessary to take the directions of the male connector 2 and the female connector 5 into consideration upon fittable connection between the male connector 2 and the female connector 5.

Both of the outermost shell 56 and the terminal support portion 54 extend along the fitting direction “α.” Moreover, the outermost shell 56 is formed as a substantially-tubular member, and on the other hand, the front protruding portion 57 of the terminal support portion 54 has a substantially-tubular outline shape as in the outermost shell 56. As clearly illustrated in FIG. 10, an inner surface 56a of the outermost shell 56 and an outer surface 57a of the front protruding portion 57 of the terminal support portion 54 are in concentric flat oval sectional shapes, and the front protruding portion 57 is positioned at the substantially center of the outermost shell 56. Such a sectional shape forms a surface abutting on a predetermined member of the male connector 2, i.e., a surface abutting on the outermost shell 21 and the terminal support portion 24, and therefore, it may be understood that FIG. 10 substantially illustrates the surface of the female connector 5 abutting on the predetermined member of the male connector 2. The diameter of the inner surface 56a of the outermost shell 56 is greater than the diameter of the outer surface 57a of the front protruding portion 57, and therefore, an annular fitting recessed portion 56b is formed between these portions. The outermost shell 21 of the male connector 2 is fitted in the fitting recessed portion 56b upon fittable connection between the male connector 2 and the female connector 5.

The terminal support portion 54 includes, specifically at an abutting surface of the front protruding portion 57 of the terminal support portion 54, two fitting portions 52A, 52B in which predetermined portions (26A, 26B) of the male connector 2 are to be fitted, and attachment portions 53A, 53B to which the interlock connector 60 is to be attached. At such an abutting surface, the fitting portions 52A, 52B are arrayed in the lateral direction along the direction “β” perpendicular to the fitting direction “α.” The fitting portions 52A, 52B are formed as raised portions protruding along the fitting direction “α.” An outer peripheral edge of the fitting raised portion 52A is defined by an outer wall 52a of the fitting raised portion 52A itself, and on the other hand, an outer peripheral edge of the fitting raised portion 52B is defined by an outer wall 52b of the fitting raised portion 52B itself. These outer peripheral edges 52a, 52b have, corresponding to the shapes defined by the inner peripheral edges 26a, 26b of the fitting recessed portions 26A, 26B, shapes slightly recessed inward at positions corresponding to the attachment portions 53A, 53B, for example. Note that the fitting recessed portions 26A, 26B and the fitting raised portions 52A, 52B are enough to form shapes complementing each other, and any fitting portion may be formed as the recessed portion or the raised portion.

The terminals 70A, 70B are placed in terminal insertion holes 58A, 58B each provided at the substantially centers of the outer peripheral edges 52a, 52b of the fitting raised portions 52A, 52B in a state in which the terminals 70A, 70B do not interfere with insertion of the terminal portions 45 of the terminals 40A, 40B.

As clearly seen from, e.g., description above, the male connector 2 and the female connector 5 substantially form complementary shapes at the abutting surface (see FIGS. 7 and 10). The phrase of “substantially form complementary shapes” means that it is enough to have the complementary shapes to such an extent that fitting is not interfered. Upon fittable connection between the male connector 2 and the female connector 5, the fitting recessed portions 26A, 26B of the male connector 2 and the fitting raised portions 52A, 52B of the female connector 5 are fitted to each other along the fitting direction “a” in a state in which these portions abut on each other at the abutting surfaces.

In this state, the fitting raised portions 52A, 52B of the male connector 2 are each fitted in the fitting recessed portions 26A, 26B of the female connector 5. As a result, the terminals 40A, 40B of the male connector 2, specifically terminal portions 45A, 45B thereof, are each inserted into the terminal insertion holes 58A, 58B provided at the fitting raised portions 52A, 52B of the female connector 5, and the terminals 40A, 40B and the terminals 70A, 70B placed in the terminal insertion holes 58A, 58B are electrically connected to each other. Moreover, in this state, the wall 57a defining the outline of the front protruding portion 57 of the terminal support portion 54 of the female connector 5 is inserted into the fitting recessed portion 21b formed by the outermost shell 21 and the front protruding portion 29 of the male connector 2, and the outermost shell 21 of the male connector 2 is further inserted into the fitting recessed portion 56b formed by the outermost shell 56 and the front protruding portion 57 of the female connector 5.

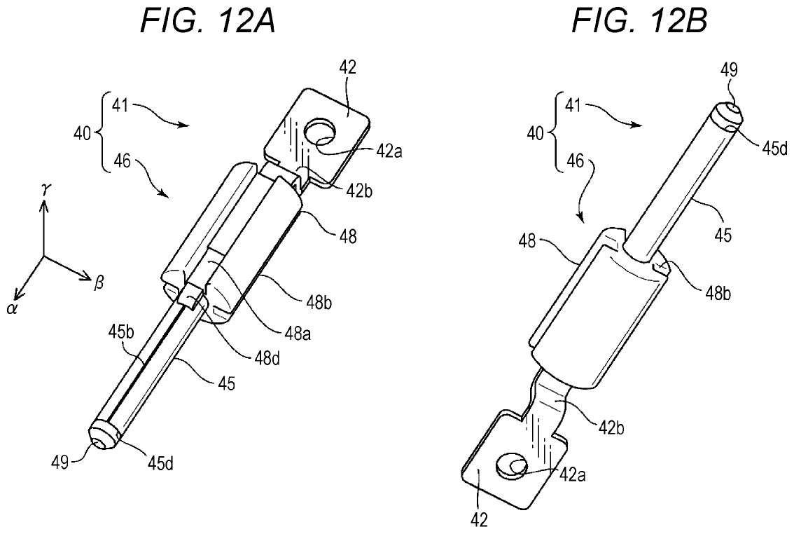

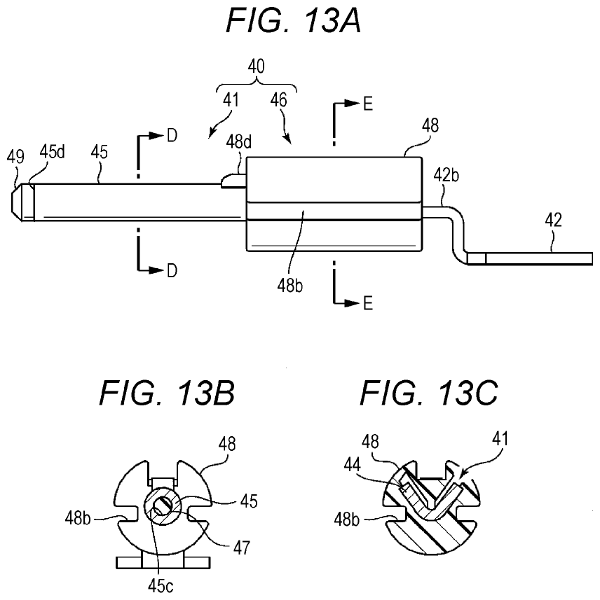

A configuration of the terminal 40 according to one embodiment of the present invention will be described with reference to FIGS. 12A to 15B. FIG. 12A is a perspective view of the terminal 40 from above, FIG. 12B is a perspective view of the terminal 40 from below, FIG. 13A is a side view of the terminal 40, FIG. 13B is a sectional view along a D-D line of FIG. 13A, and FIG. 13C is a sectional view along an E-E line of FIG. 13A.

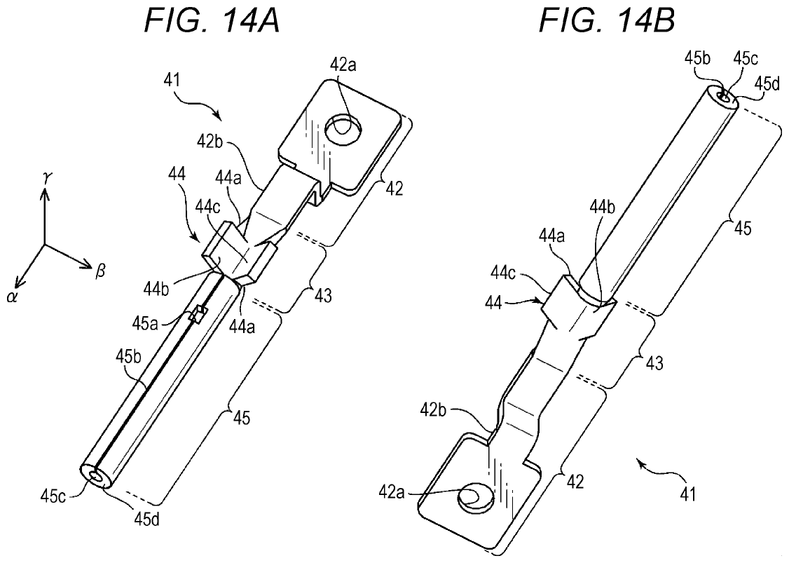

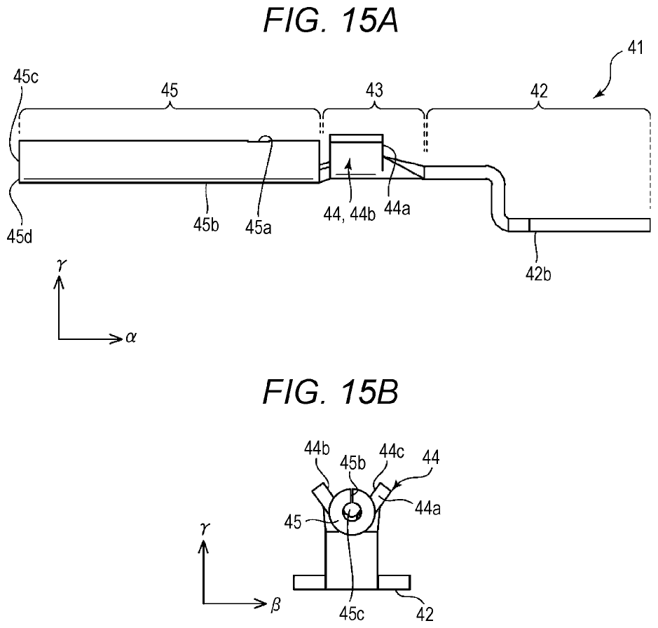

The terminal 40 includes a metal member 41 and the resin member 46 molded integrally with the metal member 41. FIG. 14A is a perspective view of the metal member 41 from above before integral molding of the resin member 46, FIG. 14B as a view corresponding to FIG. 12A is a perspective view of the metal member 41 from below, FIG. 15A as a view corresponding to FIG. 12B is a side view of the metal member 41, and FIG. 15B as a view corresponding to FIG. 13A is a back view thereof.

The metal member 41 can be, for example, formed in such a manner that a relatively-thick metal plate-shaped body having a thickness of about 1.2 mm is processed by, e.g., cutting, bending, and rounding. The relatively-thick metal plate is used as described above, and therefore, the strength of the terminal 40 can be enhanced, and the terminal 40 withstanding great current can be formed. Further, manufacturing from the single plate-shaped body can reduce, for example, a manufacturing cost as compared to the case of using a mold.

The metal member 41 roughly includes a fixing portion 42, an intermediate portion 43, and the tubular portion 45. The fixing portion 42, the intermediate portion 43, and the tubular portion 45 are arranged in this order along the fitting direction “α” toward the side fittably connected to the female connector 5, i.e., toward the abutting surface.

The fixing portion 42 is, for example, formed as a flat portion fixed to a substrate (not shown) provided inside the housing. The fixing portion 42 may have a rectangular shape as viewed in plane, and for fixing with screws, a screw hole 42a is provided at the center of the fixing portion 42. The fixing portion 42 is coupled to the intermediate portion 43 through a neck portion 42b. For facilitating connection to the substrate, a crank may be provided at the neck portion 42b.

The intermediate portion 43 is a portion connecting the fixing portion 42 and the tubular portion 45, and after formation as the terminal 40, is fully covered with the resin member 46. Thereafter, the intermediate portion 43 is not visible as long as the intermediate portion 43 is not damaged, for example. Part 44 of the intermediate portion 43 stands in a state in which a thick portion 44a of the metal plate is exposed in a “⊖-γ” plane crossing the fitting direction “α.” With such a standing portion, connection between the metal member 41 and the resin member 46 in the fitting direction “α” can be more strengthened, for example. A standing direction may be, for example, a direction at an acute angle to the flat fixing portion 42, and forms, for example, a substantially opening V-shape in the “β-γ” plane. Linear portions 44b, 44c forming the V-shape are substantially-flat plate surfaces, and are firmly connected to resin of the resin member 46.

The tubular portion 45 is formed in a tubular shape in such a manner that a side surface of a metal plate along the fitting direction “α” is wound in the lateral direction and closed at a joint 45b. The joint 45b is closed to such an extent that resin charged into an inner portion 45c of the tubular portion 45 does not leak. The outline of the tubular portion 45 at the abutting surface is a substantially circular shape. This can prevent enlargement of the male connector 2 and the female connector 5 in the array direction “β.” The tubular portion 45 is a portion physically contacting the partner terminal 70 of the female connector 5 upon fittable connection between the male connector 2 and the female connector 5.

The resin member 46 is molded only for the intermediate portion 43 and the tubular portion 45, and is not molded for the fixing portion 42. The resin member 46 at least includes a charged portion 47 (see FIG. 13B) charged into the inner portion 45c of the tubular portion 45, and a cover portion 48 covering the outside of the metal member 41, more specifically part of the tubular portion 45 and the entirety of the intermediate portion 43. The cover portion 48 includes these two resin portions provided in a continuous state.

The cover portion 48 covers only part of the tubular portion 45, and therefore, at least part of the tubular portion 45, preferably the substantially entirety of the tubular portion 45, is kept exposed to the outside. Using such a portion exposed to the outside, the tubular portion 45, i.e., the metal member 41, physically contacts the partner terminal 70. As described above, part 49 of the resin is provided in an exposed state at one end 45d of the tubular portion 45 in a state in which part 49 of the resin is continuous to the charged portion 47. Such a portion 49 functions as a finger protection.

The charged portion 47 charged into the inner portion 45c of the tubular portion 45 serves to enhance the strength of the tubular portion 45 and effectively prevent, e.g., damage and buckling of the terminal 40 upon contact with the partner terminal 70. The charged portion 47 is continuous to the cover portion 48 covering the outside of the tubular portion 45 through the resin covering the intermediate portion 43, and is further continuous to the cover portion 48 through a through-hole 45a provided at the tubular portion 45. With a continuous portion 48d through the through-hole 45a, the charged portion 47 and the cover portion 48 can be more firmly connected to each other.

The terminal 40 can be, for example, also attached to the housing 20 by means of the cover portion 48. At the cover portion 48, a groove 48b is provided corresponding to a groove (not shown) provided at the housing 20 along the fitting direction “α.” As illustrated in FIG. 8, the terminal 40 is inserted into the terminal support portion 24 along the groove 48b through the insertion port 21c provided at the terminal support portion 24. For fixing the terminal 40 at a predetermined position of the housing 20, a locking recessed portion 48a is provided at an upper portion of the cover portion 48. When the terminal 40 reaches a predetermined position of the terminal support portion 24, the locking protrusion 24b of the locking piece 24a provided at the terminal support portion 24 is fitted in the locking recessed portion 48a provided at the cover portion 48, and as a result, the terminal 40 is fixed to the housing 20. In this state, the tubular portion 45 is arranged along the fitting direction “α” in a state contactable with the partner terminal 70 in the fitting space formed by the fitting recessed portions 26A, 26B.

The present invention is not limited to the above-described embodiment, and various other changes can be made.

It should be understood that description above relates to the preferred embodiment and merely represents an article. It can be recognized that variations and corrections as different embodiments are easily apparent to those skilled in the art according to the above-described teachings. Thus, exemplary embodiments and alternative embodiments can be made without departing from the spirit of the article described in the attached claims.

### LIST OF REFERENCE NUMERALS

2 male connector
5 female connector
20 housing
23A, 23B attachment portion
26A, 26B fitting recessed portion
26a, 26b inner peripheral edge (inner wall) of fitting recessed portion
30 interlock connector
40A, 40B terminal
41 metal member
45 tubular portion (terminal portion)
46 resin member
47 charged portion
48 cover portion
50 housing
52A, 52B fitting raised portion
52a, 52b outer peripheral edge (outer wall) of fitting raised portion
53A, 53B attachment portion
60 interlock connector
70A, 70B terminal

1. A power connector comprising:
a housing having a fitting space in which a predetermined portion of a partner connector is to be fitted; and
a terminal attached to the housing,
wherein the terminal includes a metal member and a resin member molded integrally with the metal member,
the metal member has a tubular portion electrically connected to a partner terminal of the partner connector arranged in the fitting space, and
the resin member has a charged portion charged into the tubular portion and a cover portion covering an outside of the metal member in a state in which at least part of the tubular portion is exposed to the outside.

2. The power connector according to claim 1, wherein
the tubular portion is arranged in the fitting space by means of the cover portion.

3. The power connector according to claim 1, wherein
the tubular portion is formed in such a manner that a side surface along a fitting direction of the fitting space and the predetermined portion is wound in a lateral direction.

4. The power connector according to claim 1, wherein
when the terminal is attached to the housing, the tubular portion extends along the fitting direction.

5. The power connector according to claim 1, wherein the metal member is formed from a single plate-shaped body.

6. The power connector according to claim 5, wherein
at least part of the metal member covered with the cover portion stands in a direction crossing the fitting direction of the fitting space and the predetermined portion.

7. The power connector according to claim 1, wherein
the resin member covers one end of the tubular portion on a side of fitting between the fitting space and the predetermined portion.

8. The power connector according to claim 7, wherein
one end of the tubular portion is, in the fitting direction of the fitting space and the predetermined portion, at a position recessed to an opposite side of the side of fitting between the fitting space and the predetermined portion of the partner connector with respect to a fitting inlet of the fitting space.

9. A power connector device comprising:
the power connector according to claim 1, and the partner connector.

10. A terminal comprising:
a metal member; and
a resin member molded integrally with the metal member,
wherein the metal member has a tubular portion electrically connected to a partner terminal of the partner connector upon fitting to the partner connector, and
the resin member has a charged portion charged into the tubular portion, and covers one end of the tubular portion on a side of fitting to the partner connector.
